(19) United States
(12) Patent Application Publication
(10) Pub. No.: US 2009/0008918 A1
(43) Pub. Date: Jan. 8, 2009

(54) Expandable Vehicle Frame

(76) Inventors: David R. Hall, Provo, UT (US); Francis Leany, Salem, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 11/829,732

(22) Filed: Jul. 27, 2007

Related U.S. Application Data
(63) Continuation-in-part of application No. 11/773,561, filed on Jul. 5, 2007.
Application No. 11/773,561 is a continuation-in-part of application No. 11/772,334, filed on Jul. 2, 2007.

(51) Int. Cl. B62D 21/02

(52) U.S. Cl. 280/781

(57) ABSTRACT

A vehicle having a frame with at least one frame member, the frame member being adapted to support at least a portion of a weight of the vehicle and at least a portion of the frame member being tubular and radially expandable. The frame also has a manifold connected to an end of the frame member. A translation assembly is connected to the manifold.

### CROSS REFERENCE TO RELATED APPLICATIONS

This application is a continuation-in-part of U.S. patent application Ser. No. 11/773,561 which was filed on Jul. 5, 2007 and entitled Energy Storage in an Elastic Vessel. U.S. patent application Ser. No. 11/773,561 is a continuation-in-part of U.S. patent application Ser. No. 11/772,334 which was filed on Jul. 2, 2007 and entitled Energy Storage. This application is inhere incorporated by reference for all that is discloses.

### BACKGROUND OF THE INVENTION

This invention relates to a vehicle frame. Some inventions of the prior art disclose various embodiments designed to provide frames which allow a certain degree of flexibility while in operation.

U.S. Pat. No. 652,942, to Whitney, which is herein incorporated by reference for all that it contains, discloses a vehicle wherein the frame is preferably constructed of tubing to secure lightness, strength, and a certain flexibility, the parts being securely connected and held together by suitable joints or couplings to maintain its rectangular shape, while providing for flexibility.

U.S. Pat. No. 3,266,815, to Bishop, which is herein incorporated by reference for all that it contains, discloses an articulated, load equalizing suspension system for a four-wheel vehicle, which protects the load carried by the vehicle from substantially all torsional stresses resulting from unevenness in the terrain being traversed.

### BRIEF SUMMARY OF THE INVENTION

In one aspect of the invention, a vehicle having a frame with at least one frame member, the frame member being adapted to support at least a portion of a weight of the vehicle and at least a portion of the frame member being tubular and radially expandable. The frame also has a manifold connected to an end of the frame member. A translation assembly is connected to the manifold. The dimension may be a length or a width.

The frame may comprise a second manifold connected to a second end of the tubular frame member. The vehicle may comprise a second translation assembly connected to the second manifold. The vehicle may be an automobile, a golf cart, a 3-wheeler, a 4-wheeler, a bulldozer, a motorcycle, truck, fork lift, or a combination thereof.

The frame member may also be axially compressible. The frame member may also be axially flexible. The frame member may also be torsionally flexible. The frame may comprise a plurality of frame members comprising at least a portion being tubular and radially expandable. The frame members may be connected by a plurality of manifolds at corners of the frame. The frame member may comprise a rigid portion. In some embodiments, a rigid element may be disposed within the frame member. The rigid element may be a fluid conduit. A pressurizing mechanism nay be attached to the frame.

The frame member may be a hose. The hose may comprise a material selected from the group consisting of composite material, Kevlar, polyurethane, polyethylene, Twaron, aramid fiber, nylon, rubber, carbon, synthetic polymers, chloroprene, elastomers, polyester, carbon fiber, glass fiber, and a combination thereof. The hose may be adapted to store hydraulic energy. Hydraulic pressure in the hose may be controlled by electronic equipment disposed within the vehicle. The hose may be in hydraulic communication with a hydraulic actuator.

In another aspect of the invention, a vehicle may comprise a frame comprising at least one frame member, the frame member spanning at least a portion of a dimension of the vehicle and at least a portion of the frame member being tubular and flexible. The frame may also comprise a manifold connected to an end of the frame member. A translation assembly may be connected to the manifold.

### BRIEF DESCRIPTION OF THE DRAWINGS

FIG. 1 is an exploded diagram of an embodiment of a vehicle.

FIG. 2 is a sectional diagram of an embodiment of a manifold of a vehicle frame.

FIG. 3 is an orthogonal diagram of an embodiment of a vehicle frame.

FIG. 4 is a sectional diagram of another embodiment of a vehicle.

FIG. 5 is a cross-sectional diagram of another embodiment of a frame member.

FIG. 6 is an orthogonal diagram of an embodiment of a plurality of frame members.

FIG. 7 is a cross-sectional diagram of another embodiment of a plurality of frame members.

FIG. 8 is a cross-sectional diagram of another embodiment of a frame member.

FIG. 9 is a cross-sectional diagram of an embodiment of a frame member connected to a manifold.

FIG. 10 is a cross-sectional diagram of another embodiment of a frame member connected to a manifold.

FIG. 11 is a cross-sectional diagram of another embodiment of a frame member connected to a manifold.

FIG. 12 is a cross-sectional diagram of another embodiment of a frame member connected to a manifold.

FIG. 13 is an orthogonal diagram of another embodiment of a vehicle frame.

FIG. 14 is a perspective diagram of another embodiment of a vehicle frame.

FIG. 14a is a perspective diagram of another embodiment of a vehicle frame.

FIG. 14b is a cross sectional diagram of another embodiment of a vehicle frame.

FIG. 14cis a perspective diagram of another embodiment of a vehicle frame.

FIG. 14d is a cross sectional diagram of another embodiment of a vehicle frame.

FIG. 15 is an orthogonal diagram of another embodiment of a vehicle.

FIG. 16 is a perspective diagram of an embodiment of a golf cart.

FIG. 17 is an orthogonal diagram of an embodiment of a motorcycle.

### DETAILED DESCRIPTION OF THE INVENTION AND THE PREFERRED EMBODIMENT

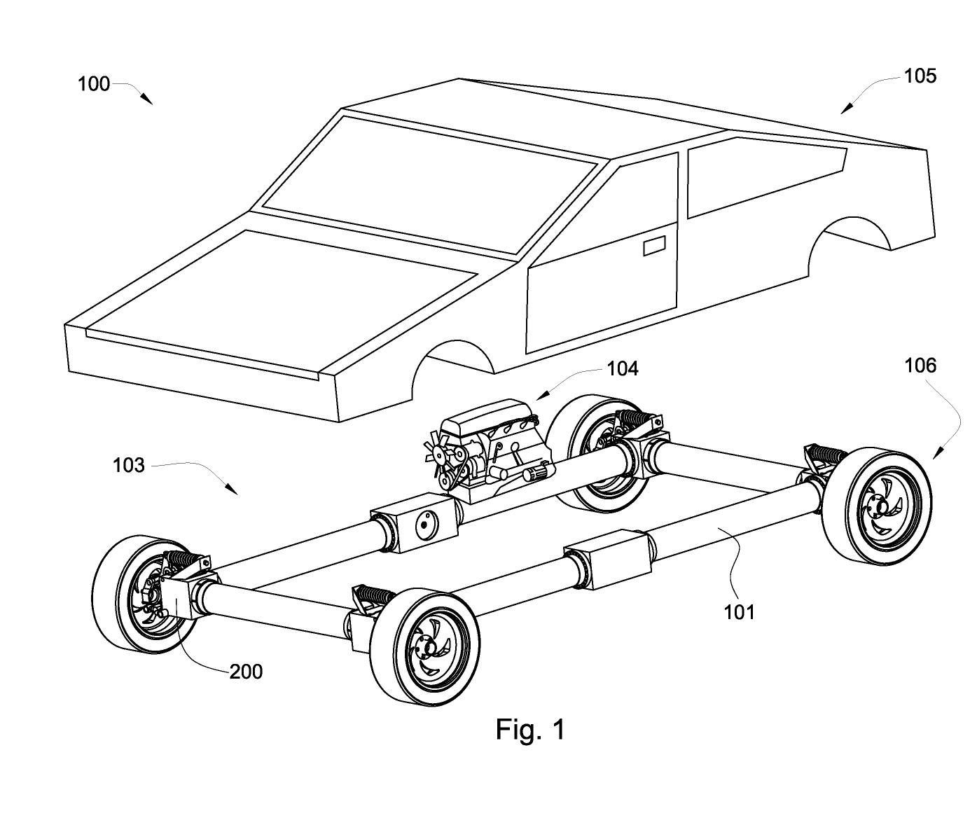

Referring to the exploded diagram in FIG. 1, a translatable vehicle 100 comprises an energy storage system adapted to store hydraulic energy to be used in propelling the vehicle 100. Unlike typical bladder accumulators of the prior art which rely on a compressible gas to store potential energy, the potential energy of the present invention is stored in the elastic material making up at least a portion of a frame member 101 coupled to the vehicle 100. The frame member 101 may be a hose, as in the current embodiment. At least a portion of the frame member 101 is tubular and is radially expandable. Hydraulic fluid stored in the frame member 101 may be a compressible fluid, an incompressible fluid or a combination thereof. In some embodiments, a compressible fluid may also store some of the potential energy. In some embodiments, the compressible fluid may store at least 10 percent of the stored energy; in other embodiments, the compressible fluid stores at least 25 percent of the stored energy. In the current embodiment, the frame member 101 is a plurality of hoses making up at least a part of the vehicle frame 103. The frame member 101 may comprise a strong, flexible material, capable of withstanding high amounts of pressure. In some embodiments, the pressure may be between 1,000 psi to 50,000 psi; in other embodiments, the pressure is between 10,000 to 20,000 psi. The material may be a material selected from the group consisting of a composite material, Kevlar, polyurethane, polyethylene, Twaron, aramid fiber, nylon, rubber, carbon, synthetic polymers, chloroprene, elastomers, polyester, carbon fiber, glass fiber, and a combination thereof. The material may be a woven fiber, a plurality of strips, or a combination thereof. At high pressure, the frame member 101 may also stiffen the frame 103.

The vehicle 100 may comprise an engine 104 connected to the frame 103. The frame 103 may be made of a plurality of frame members 101 connected by a plurality of manifolds 200 at each corner of the frame 103. The engine 104 may be a small, efficient engine to reduce size and weight, thus saving gas per mile. The vehicle 100 may also comprise a cab 105 attached to the frame 103. Translation assemblies 106 such as wheels may be connected to the frame 103.

The frame member 101 is adapted to receive hydraulic fluid and stores energy in the form of potential energy. The potential energy is stored in the material of the frame member 101 as its volume expands due to receiving hydraulic fluid. The potential energy stored in the frame member 101 may be converted into kinetic energy by ejecting the fluid from the frame member 101 into a rotary mechanism, which may then apply torque to at least a portion of the translation assembly 106.

In some embodiments a covering may be placed over the frame members. This may serve as a shield should the frame member burst due to over pressurization or an impact. The covering may be an elastic hose, aluminum, a light weight metal, carbon fiber, fiberglass, etc. In some embodiments, the covering may be an elastic hose which is filled with a foam, a low pressurized liquid or gas, an inert gas, nitrogen gas, water or combinations thereof.

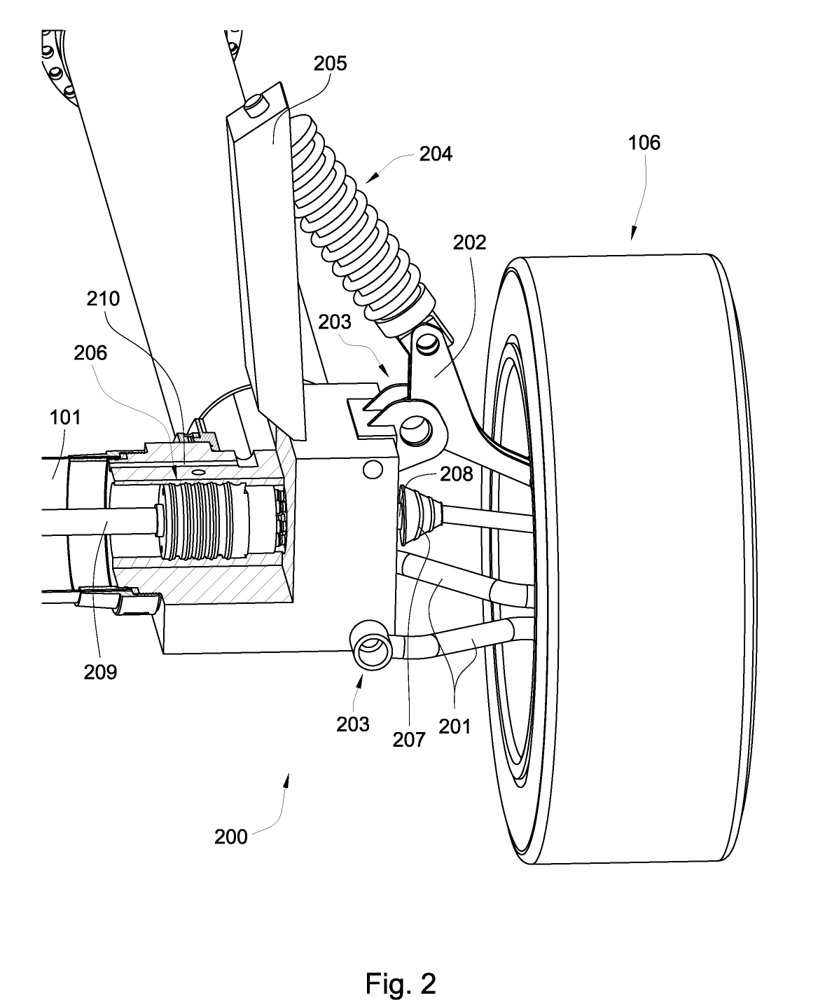

Each translation assembly 106 may be connected to a manifold 200 at each corner of the vehicle, as in the embodiment of FIG. 2. The translation assembly 106 may be connected to the manifold 200 by a plurality of lower arms 201 and an upper arm 202 rotatably connected to hinges 203 on the manifold 200. The manifold 200 may comprise a strut 204 rotatably connected to the upper arm 202 and affixed to a mount 205 on the manifold 200 (though the strut and mount are shown elevated so that the cross-section of the manifold may be seen). The strut 204 may allow for the frame 103 to provide impact shock absorption to the vehicle 100 on uneven surfaces. The corner manifold 200 may comprise a rotary mechanism 206 or other hydraulic actuator such as a pump or a motor such that hydraulic fluid from the frame member 101 may be used to apply a rotational torque to the translation assembly 106 or a portion of the translation assembly 106. A joint 207 such as a CV joint may join the translation assembly 106 to a shaft 208 attached to the rotary mechanism 206 such that the energy storage system may be able to transmit rotational power to the translation assembly 106 at various angles, which may be especially useful on uneven surfaces.

A rigid element 209 may be disposed within the frame member 101. The rigid element 209 may be a fluid conduit wherein a low pressure hydraulic fluid may be allowed to circulate through the rigid element 209 while a high pressure hydraulic fluid may be allowed to circulate through the frame member 101 at the same time. The high and low pressure fluids may be used to control the rotation of the translation assembly 106. The frame members 101 may be in fluid communication with each other through a fluid passageway 210 formed in the manifold 200. The low pressure fluid may be pressurized to a pressure significantly lower than that of the high pressure fluid, preferably under 500 psi. The low pressure may be pressurized by a compressible bladder, a flexible hose, or other pressurizing mechanism. The low pressure fluid may also be disposed within an element outside of the frame member 101.

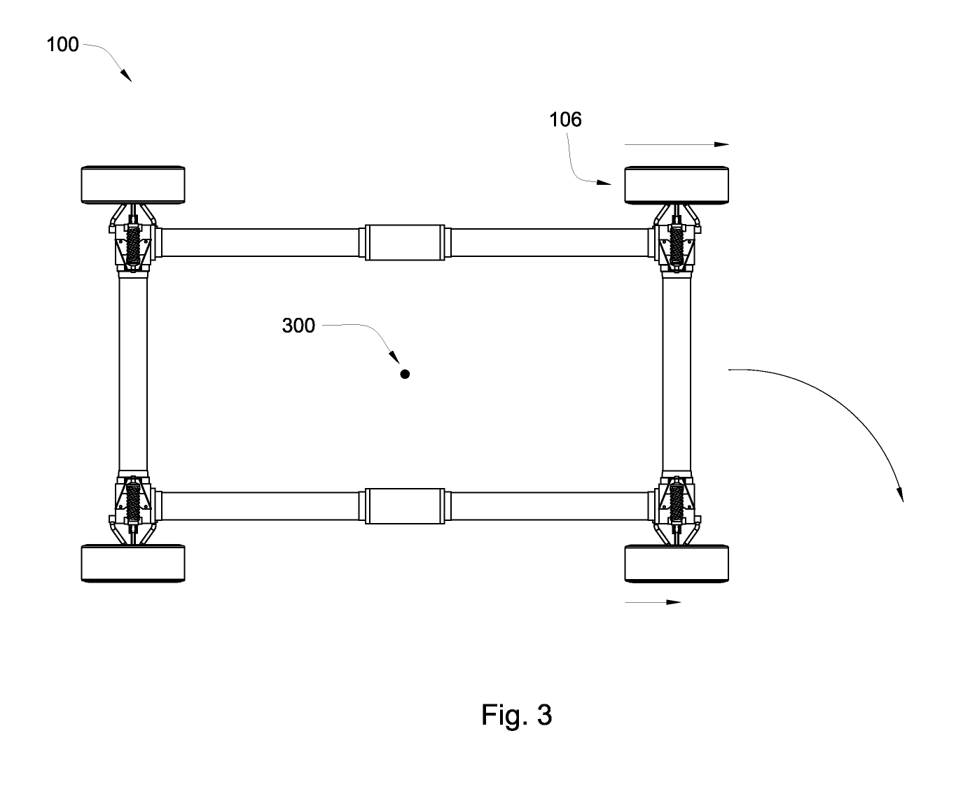

Each translation assembly may be associated with an independent mechanical transmission, which may allow for translation assemblies 106 to be propelled at different rates which causes the vehicle to turn, as in the embodiment of FIG. 3. This system may also be used to turn the vehicle 100 at a very high rate or to rotate the vehicle about a central point 300 by reversing the translation assemblies 106 on one side of the vehicle 100 while the other translation assemblies 106 move forward. In embodiments where the independent mechanical transmission is a rotary mechanism 206, the direction and speed of each translation assembly 106 may be controlled by the position of the swashplate.

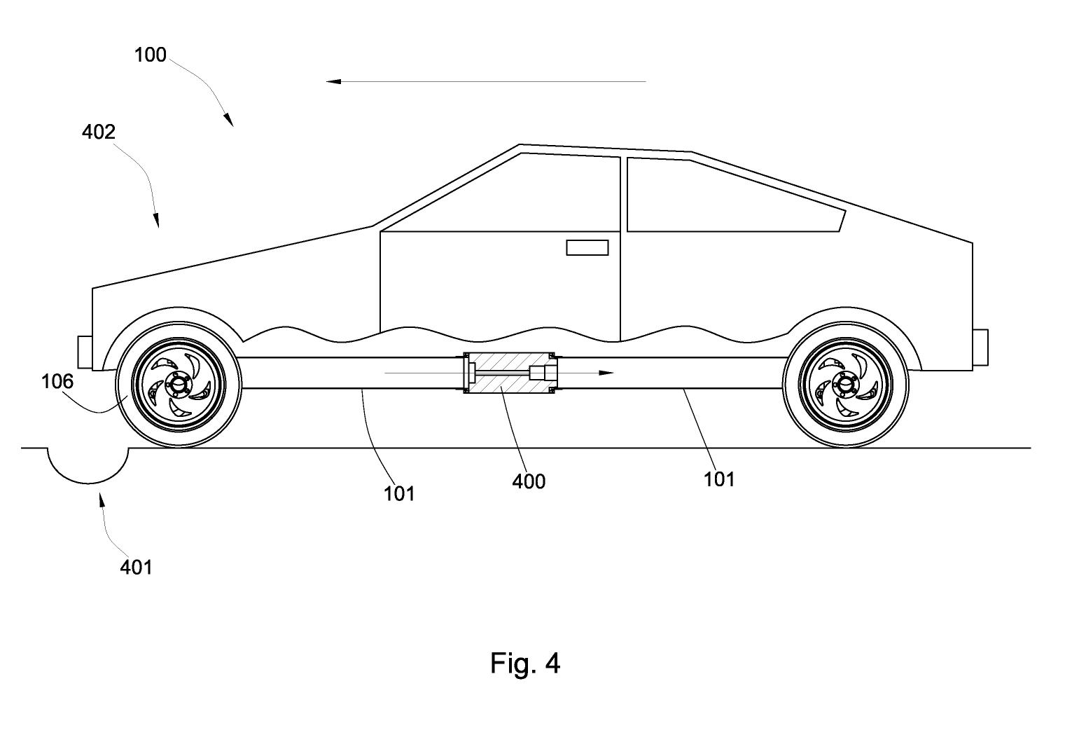

The pressure in each frame member 101 may be adjusted while the vehicle is in operation, as in the embodiment of FIG. 4. As the vehicle 100 is about to pass over a dip 401, bump, pothole, track, or other uneven terrain, sensors at the front 402 of the vehicle may detect the uneven terrain. The sensors may be in communication with other electronic equipment which may control the pressure in the frame members 101. As a translation assembly 106 approaches the uneven terrain, the pressure in the frame member(s) 101 proximate the translation assembly may shift to another frame member 101 (as indicated by arrow 400), such that the frame member(s) 101 proximate the translation assembly 106 may become more flexible, which may provide better shock absorption for the vehicle 100. After the translation assembly 106 passes over the uneven terrain, the pressure in the frame members 101 nay return to their original pressure.

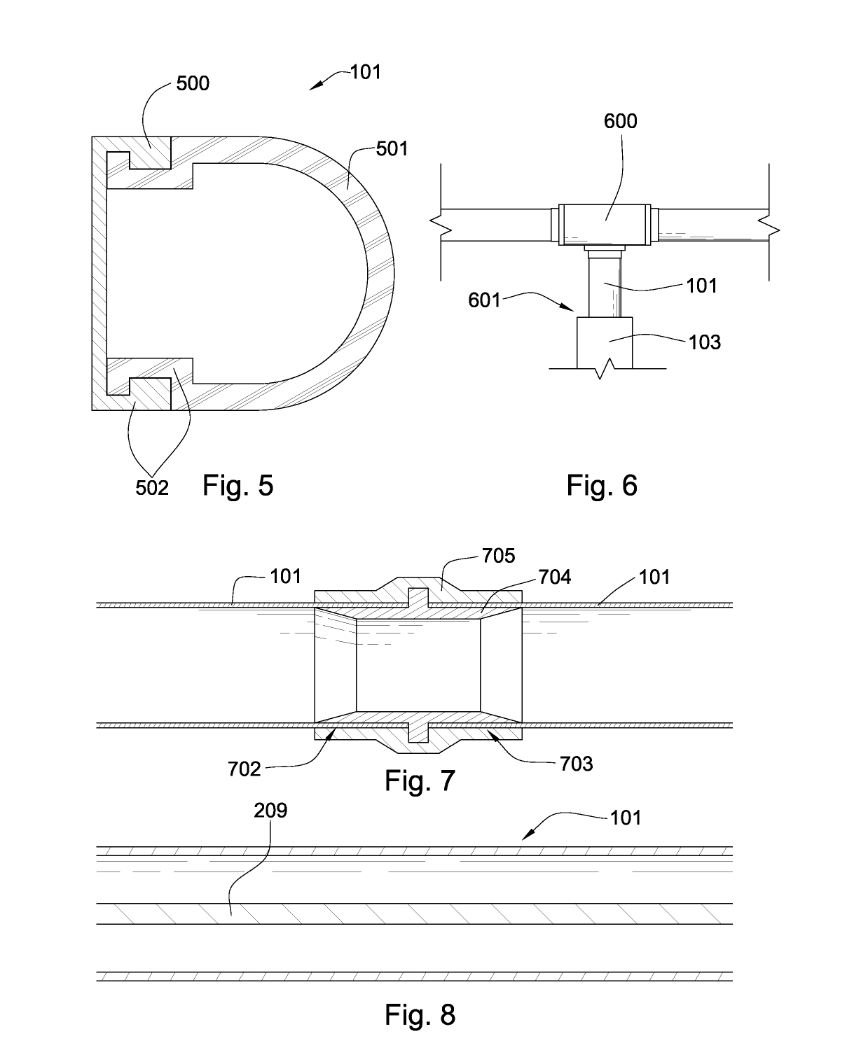

The hose 101 may comprise a rigid portion 500 in addition to an elastic portion 501 comprising energy-storing material, as in the embodiment of FIG. 5. The rigid portion 500 may provide strength to the hose 101, while the elastic portion 501 still allows the hose 101 to store energy. The rigid portion 500 may be made of metal or other rigid material. The two portions 500, 501 of hose 101 may be interlocked by tabs 502. As the elastic portion 501 expands due to an increasing volume of hydraulic fluid within the hose 101, the tabs 502 may allow the two portions 500, 501 to hold tightly together such that all of the hydraulic fluid is contained entirely within the hose 101.

The energy storing system may comprise a plurality of frame members 101 connected by a manifold 600, as in the embodiment of FIG. 6. The hoses 101 may be attached to the manifold 600 such that they are in fluid communication with each other. The pressurizing mechanism 103 may be attached to an end 601 of one of the frame members 101 such that the mechanism 103 pressurizes the entire hose 101. This may allow for the hydraulic circuit 100 to comprise more than one hydraulic actuator 102 in communication with the hose 101.

As in the embodiment of FIG. 7, the hose 101 may comprise a plurality of frame members 101, such that the hose 101 may extend farther or may have more energy storage potential. The frame members 101 may be held together with a clamp 601 at ends 702, 703 of each frame member 101. The ends 702, 703 may be fitted around an inner element 704 of the clamp 701, after which an outer element 705 of the clamp 701 may be fitted around the hose 101 and inner element 704. The rigid element 209 disposed within the hose 101 may be a solid rod, as in the embodiment of FIG. 8. The rigid element 209 may be for axial stability.

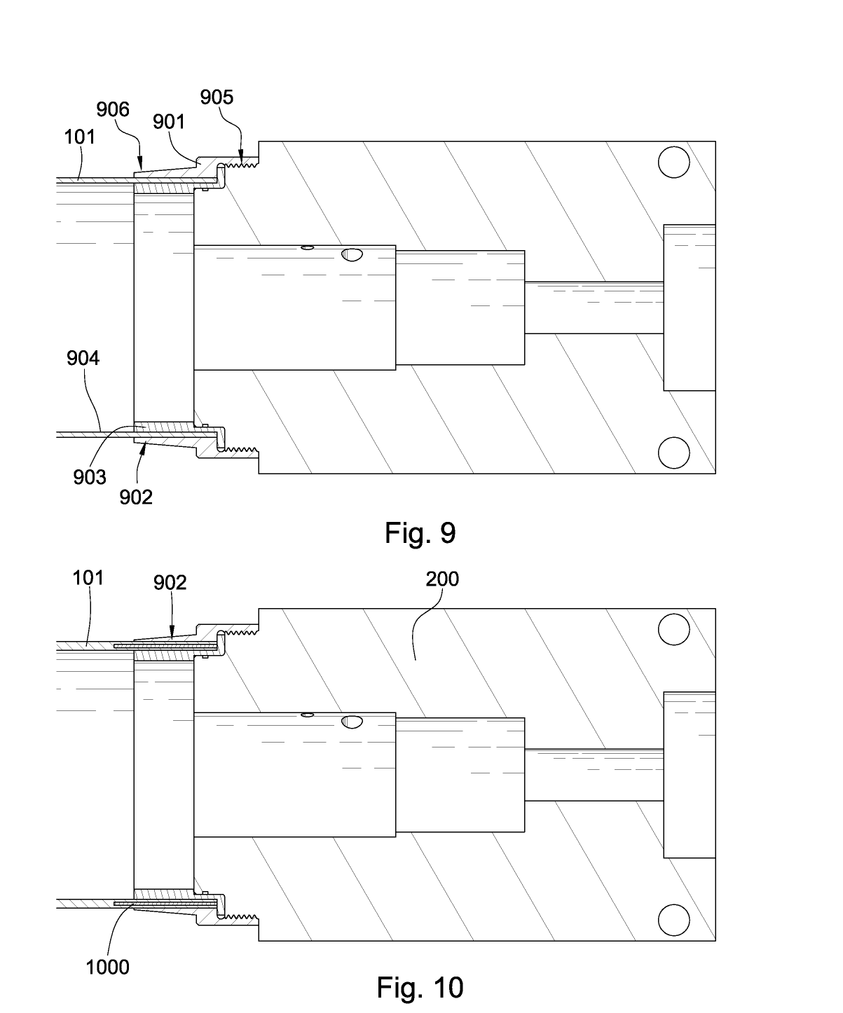

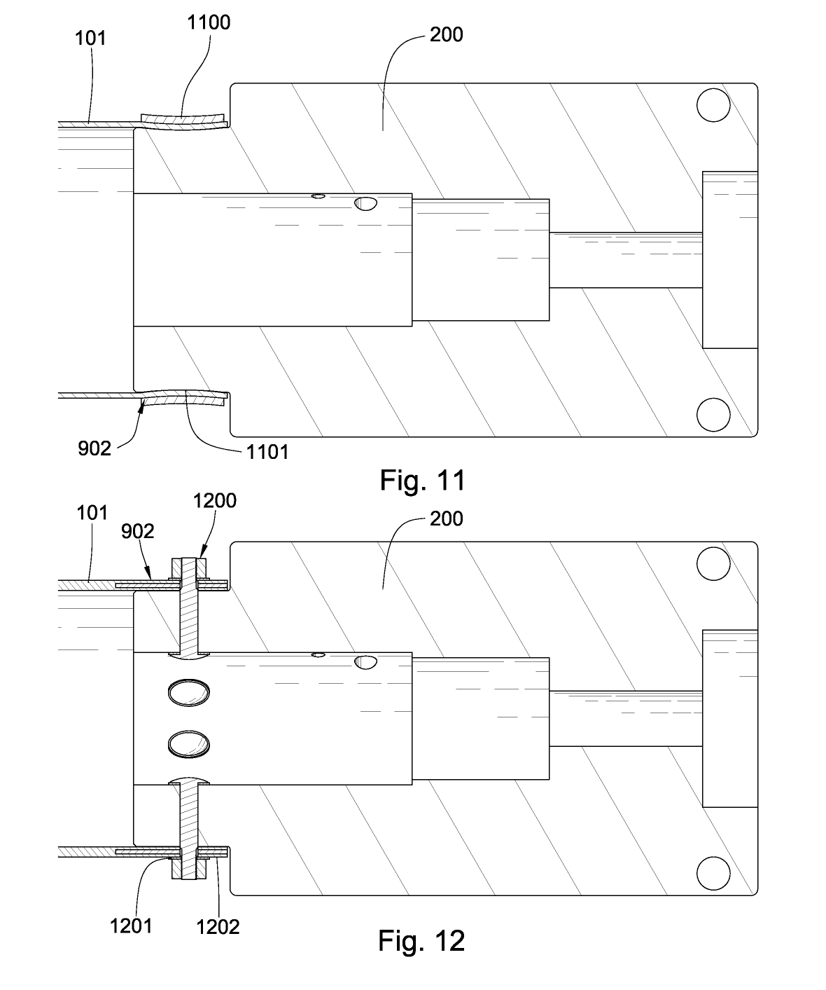

The frame member 101 may be connected to the manifolds 200 in such a way as to prevent leaking. Several different embodiments are shown in FIGS. 9 through 12. Each frame member 101 may be connected to the manifold 200 by a threaded connection, as in the embodiment of FIG. 9. A threaded metal ring 901 may be disposed around an end 902 of the frame member 101 and a second metal ring 903 may be inserted in an inner diameter 904 of the frame member 101 such that when the threaded metal ring 901 is connected to a threaded portion 905 of the manifold 200, the two metal rings 901, 903 may grip the frame member end 902 and create a sealed connection. The metal rings 901, 903 may comprise a tapered thickness 906. This may reduce pinching on the frame member 101, particularly when the frame member 101 is radially stretched. The frame member 101 may comprise metal strips or pins 1000 disposed within the end 902, which may improve the material integrity of the frame member 101 proximate the connection, as in the embodiment of FIG. 10. The frame member end 902 may be clamped onto the manifold 200 by a band 1100, as in the embodiment of FIG. 11. The manifold 200 may comprise a radial depression 1101 at the connection, which may prevent the band 1100 from sliding. The band 1100 may be a metal heat shrink band. The frame member 101 may be connected to the manifold 200 with a plurality of fasteners 1200 such as bolts, as in the embodiment of FIG. 12. A metal ring 1201 may be disposed around the outer diameter 1202 of the frame member end 1002, which may provide additional support to the frame member 101 where the fasteners 1200 are positioned. In some embodiments, the elastic modulus of the frame member may vary depending on the location of the frame member. For example, it may be desirable for the frame member to be more rigid proximate the connection to the manifolds than in the center of the frame member to reduce stress risers that may occur at the transitions between flexible and rigid components. The elastic modulus of the frame member may be controlled by how the fibers are woven or joined in the elastic material.

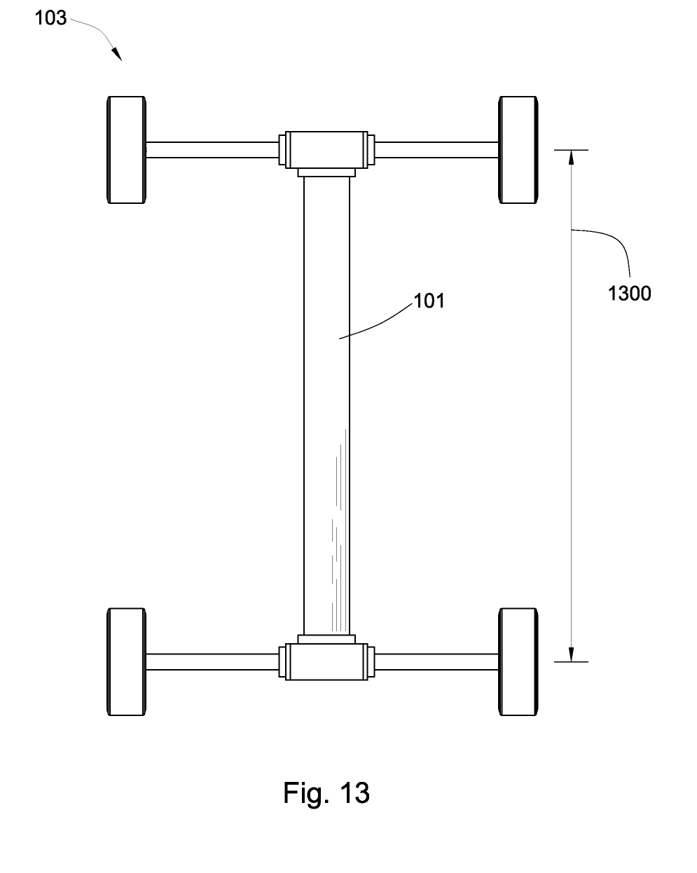

The frame member 101 may span an entire length 1300 of the frame 103, as in the embodiment of FIG. 13. This may allow the vehicle to have greater lateral, axial, or torsional flexibility, which may also be advantageous while the vehicle is turning. The frame member 101 may also be axially compressible, which may provide some shock absorption or protection if the vehicle is in an accident. The frame member 101 may also span at least a portion of a length, a width, a diagonal, or any dimension of the vehicle.

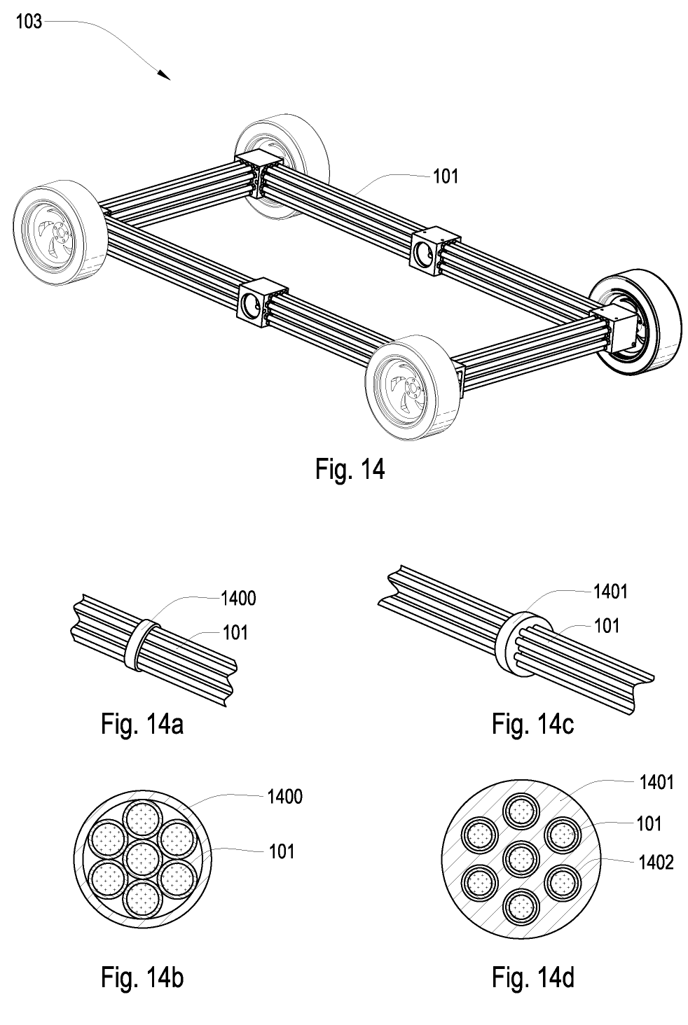

Referring to the embodiment of FIG. 14, the vehicle may comprise a plurality of frame members 101 running generally parallel to one another to form the frame 103 of the vehicle. The plurality of frame members 101 may be spaced apart to allow for efficient cooling of the hydraulic fluid in the frame members 101. In some embodiments, the parallel frame members may be secured to one another to improve stiffness. For example the parallel members may be glued, clamped, fixed, banded, or held together. The parallel frame members may be held together at a single location along their length, at the ends, at multiple locations along their length, or combinations there of. A securing mechanism which is also expandable may be used. FIG. 14a discloses a band 1400 (which is shown as a cross section in FIG. 14b) to bundle the frame members 101 together. The band 1400 may be rigid, elastic, or semi-elastic. An elastic band may expand as the frame members 101 expand. FIG. 14c (which is shown as a cross section in FIG. 14d) discloses a fixture 1401 which also bundle the frame members together. Such a fixture 1401 may comprises a plurality of holes 1402 which are spaced at predetermined distance to ensure a gap between the frame members 101. Bands and fixtures may be used in combinations with each other to modify to the stiffness of the frame.

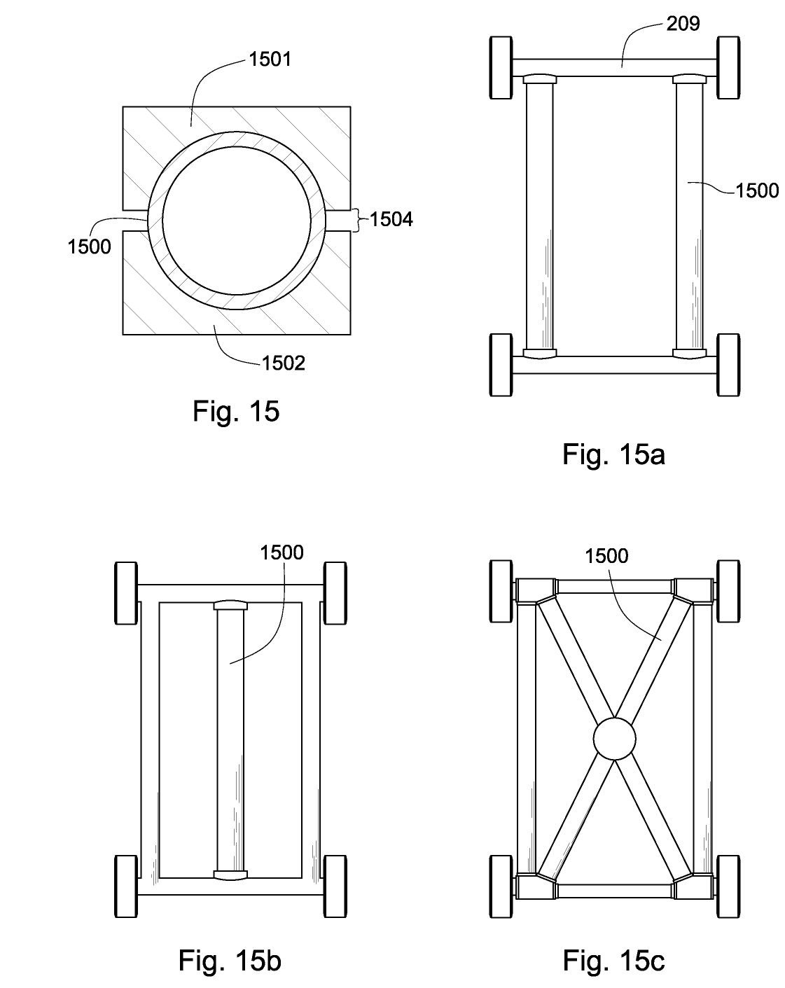

The expandable portion 1500 of each frame member 101 may be disposed intermediate a plurality of rigid portions 1501, 1502, as in the embodiment of FIG. 15. A cab of the vehicle 100 may be attached to an upper rigid portion 1501, wherein a gap 1504 exists between the upper rigid portion 1501 and a lower rigid portion 1502. The rigid portions 1501, 1502 may be secured around the expandable portion 1500 such that as the vehicle 100 is in operation, the rigid portions 1501, 1502 remain disposed around the expandable portion 1500. The gap 1504 may allow the expandable portion 1500 of the frame member 101 to be compressed in order to provide additional shock absorption to the vehicle 100 as it traverses uneven surfaces.

FIG. 15a discloses a frame comprising expandable portions running along the length of the frame and rigid elements running along the width of the frame. FIG. 15b discloses a frame with a central expandable member 1500. FIG. 15c discloses an expandable member 1500 running is diagonal directions.

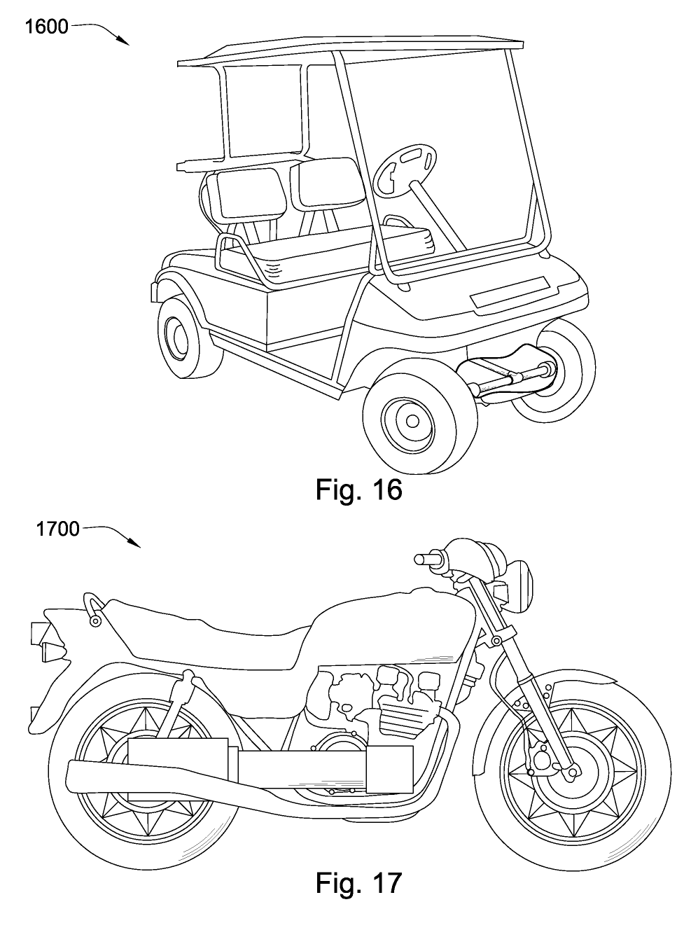

The current invention may be used in various vehicles, such as a golf cart 1600, as in the embodiment of FIG. 16, or a motorcycle 1700, as in the embodiment of FIG. 17. The frame may be lighter in weight than or substantially equal to conventional vehicle frames. One advantage of a lighter frame may be that the vehicle may get better gas mileage. The frame may also be used in other automobiles, a truck, a 3-wheeler, a 4-wheeler, a bulldozer, or a combination of any.

Whereas the present invention has been described in particular relation to the drawings attached hereto, it should be understood that other and further modifications apart from those shown or suggested herein, may be made within the scope and spirit of the present invention.

1. A vehicle, comprising:
a frame comprising at least one frame member, the frame member supporting at least a portion of a weight of the vehicle and being a hose made of an elastic material which stores energy used in propelling the vehicle;
the frame also comprising a manifold connected to an end of the frame member; and
a translation assembly connected to the manifold;
wherein when the frame member is pressurized to over 1,000 psi, the elastic material comprises the characteristic of storing over half of the energy.

2. (canceled)

3. The vehicle of claim 1, wherein the frame comprises a second manifold connected to a second end of the tubular frame member.

4. The vehicle of claim 3, wherein the vehicle comprises a second translation assembly connected to the second manifold.

5. The vehicle of claim 1, wherein the frame member is also axially compressible.

6. The vehicle of claim 1, wherein the frame member is also axially flexible.

7. The vehicle of claim 1, wherein the frame comprises a plurality of frame members comprising at least a portion being tubular and radially expandable.

8. The vehicle of claim 7, wherein the frame members are connected by a plurality of manifolds at corners of the frame.

9. (canceled)

10. The vehicle of claim 1, wherein the hose comprises a material selected from the group consisting of composite material, Kevlar, polyurethane, polyethylene, Twaron, aramid fiber, nylon, rubber, carbon, synthetic polymers, chloroprene, elastomers, polyester, carbon fiber, glass fiber, and a combination thereof.

11. (canceled)

12. (canceled)

13. The vehicle of claim 1, wherein the hose is in hydraulic communication with a hydraulic actuator.

14. The vehicle of claim 1, wherein the frame member comprises a rigid portion.

15. The vehicle of claim 1, wherein a rigid element is disposed within the frame member.

16. The vehicle of claim 15, wherein the rigid element is a fluid conduit.

17. The vehicle of claim 1, wherein the vehicle is an automobile, a golf cart, a 3-wheeler, a 4-wheeler, a bulldozer, a motorcycle, truck, forklift, or a combination thereof.

18. The vehicle of claim 1, wherein the frame member is also torsionally flexible.

19. (canceled)

20. A vehicle, comprising:
a frame comprising at least one frame member, the frame member supporting at least a portion of a weight of the vehicle and at least a portion of the frame member being a hose made of an elastic material which stores energy used in propelling the vehicle;
the frame also comprising a manifold connected to an end of the frame member; and
a translation assembly connected to the manifold.
wherein when the frame member is pressurized to over 1,000 psi, an elastic material of the frame member comprises the characteristic of storing over half of the energy.
